(19) United States
(12) Patent Application Publication
(10) Pub. No.: US 2022/0400309 A1
(43) Pub. Date: Dec. 15, 2022

(54) ENGAGEMENT ESTIMATION APPARATUS, ENGAGEMENT ESTIMATION METHOD AND PROGRAM

(71) Applicant: Nippon Telegraph and Telephone Corporation, Tokyo (JP)

(72) Inventors: Taichi KAWANO, Musashino-shi, Tokyo (JP); Kazuhisa YAMAGISHI, Musashino-shi, Tokyo (JP); Pierre LEBRETON, Musashino-shi, Tokyo (JP)

(21) Appl. No.: 17/775,640

(22) PCT Filed: Nov. 11, 2019
(86) PCT No.: PCT/JP2019/044168

§ 371 Date: May 10, 2022

(51) Int. Cl. H04N 21/442

(52) U.S. Cl. CPC H04N 21/44204

(57) ABSTRACT

An engagement estimation device includes an engagement estimation unit which calculates an estimated value of an index for assessing engagement of a viewer of a video at a certain elapsed time from a start of playback of the video distributed via a network, and the engagement estimation unit calculates the estimated value such that, in the case where the playback of the video is stopped at the certain elapsed time, the stop of the playback influences the estimated value more significantly than in the case where the playback of the video is not stopped at the certain elapsed time.

### TECHNICAL FIELD

The present invention relates to an engagement estimation device, an engagement estimation method, and a program.

### BACKGROUND ART

Communication services (voice communication, video communication, Web, IoT, and the like) for transferring video, sound (hereinafter including voice), and text between terminals or between a server and a terminal via the Internet are popular.

The Internet is a network in which communication quality is not necessarily guaranteed and hence, in the case where communication is performed with an audio medium or a visual medium, packet loss, packet transfer delay, and packet retransmission occur due to a reduction in bit rate and line congestion caused by narrowness of the bandwidth of a line between a viewer terminal and a network, and the quality of the audio medium or the visual medium perceived by a viewer is degraded.

Specifically, in adaptive bit rate video streaming in which a video is distributed while the bit rate of the audio or visual medium is changed according to the state of the throughput of the network, reductions in sound quality and image quality caused by a reduction in throughput occur, and a wait for a playback start and a playback stop caused by buffering processing which occurs due to the fact that a predetermined amount of data is not accumulated in a buffer of a receiving terminal also occur.

The reduction in bit rate, the wait for the playback start, and the playback stop influence not only quality experienced by a user but also engagement (viewing time, viewing permission suspension/discontinuation, viewing cancellation).

Accordingly, in order for a video distributor to determine whether the above-described video communication service is provided with excellent quality and engagement, it is important to be able to measure audiovisual quality experienced by the viewer and engagement during the provision of the service to monitor high levels of the audiovisual quality and the engagement provided to the viewer.

Consequently, a quality estimation technique and an engagement estimation technique capable of properly expressing the audiovisual quality experienced by the viewer and the engagement are necessary.

One of conventional objective quality assessment methods is ITU-T recommendation P. 1203 shown in NPL 1 or a technique shown in NPL 2. The present technique is a technique in which quality is estimated from packets received by a receiving terminal (a smartphone or an STB (Set-Top Box)) by using quality parameters such as a resolution, a frame rate, a bit rate, a playback start waiting time, and a playback stop time of a video.

### CITATION LIST

### Non Patent Literature

[NPL 1] Parametric bitstream-based quality assessment of progressive download and adaptive audiovisual streaming services over reliable transport, ITU-T P. 1203
[NPL 2] K. Yamagishi and T. Hayashi, “Parametric Quality-Estimation Model for Adaptive-Bitrate Streaming Services,” IEEE Transactions on Multimedia, 2017. DOI: 10. 1109/TMM. 2017. 2669859.

### SUMMARY OF THE INVENTION

### Technical Problem

However, in the case where the video distributor attempts to monitor the engagement (viewing time, viewing permission suspension/discontinuation, hereinafter viewing discontinuation will be described) by using information in a user terminal, an engagement estimation technique is necessary, and such a technique does not exist at the moment.

The present invention has been made in view of the above points, and an object thereof is to allow estimation of engagement from parameters which can be observed in a terminal.

### Means for Solving the Problem

In order to solve the above problem, an engagement estimation device includes an engagement estimation unit which calculates an estimated value of an index for assessing engagement of a viewer of a video at a certain elapsed time from a start of playback of the video distributed via a network, and the engagement estimation unit calculates the estimated value such that, in a case where the playback of the video is stopped at the certain elapsed time, the stop of the playback influences the estimated value more significantly than in a case where the playback of the video is not stopped at the certain elapsed time.

### Effects of the Invention

It is possible to allow the estimation of the engagement from parameters which can be observed in the terminal.

### BRIEF DESCRIPTION OF DRAWINGS

FIG. 1 is a view showing examples of hardware elements of an engagement estimation device 10 in an embodiment of the present invention.

FIG. 2 is a view showing examples of functional elements of the engagement estimation device 10 in the embodiment of the present invention.

FIG. 3 is a view showing, by way of example, variables used in calculation of a viewing discontinuation value in the case where a playback stop is not present at an elapsed time t.

FIG. 4 is a view showing, by way of example, variables used in the calculation of the viewing discontinuation value in the case where the playback stop is present at the elapsed time t.

FIG. 5 is a flowchart for explaining an example of a processing procedure executed by the engagement estimation device 10.

FIG. 6 is a flowchart for explaining an example of a processing procedure of calculation processing of the viewing discontinuation value.

### DESCRIPTION OF EMBODIMENTS

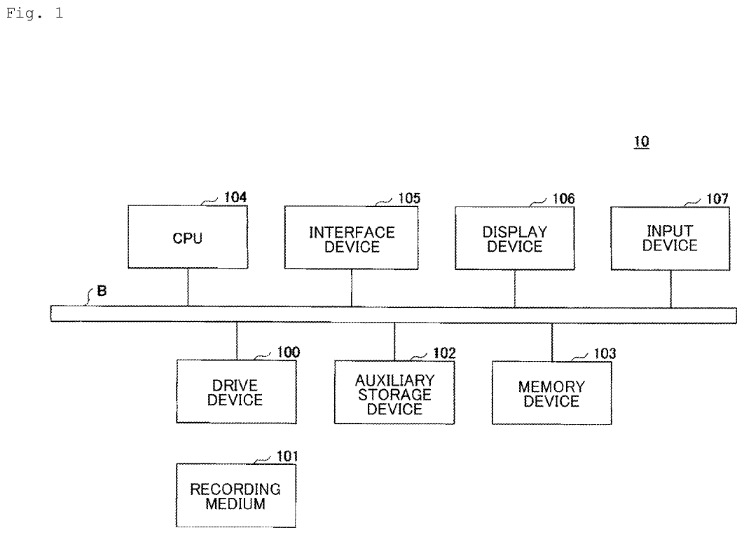

Hereinbelow, an embodiment of the present invention will be described based on the drawings. FIG. 1 is a view showing examples of hardware elements of an engagement estimation device 10 in the embodiment of the present invention. The engagement estimation device 10 in FIG. 1 has a drive device 100, an auxiliary storage device 102, a memory device 103, a CPU 104, an interface device 105, a display device 106, and an input device 107 which are connected to each other via a bus B.

A program for implementing processing in the engagement estimation device 10 is provided by a recording medium 101 such as a CD-ROM. When the recording medium 101 in which the program is stored is set in the drive device 100, the program is installed in the auxiliary storage device 102 from the recording medium 101 via the drive device 100. Note that the installation of the program does not necessarily need to be performed from the recording medium 101, and the program may also be downloaded from another computer via a network. The auxiliary storage device 102 stores the installed program and also stores required files and data.

In the case where an instruction to activate the program is issued, the memory device 103 reads the program from the auxiliary storage device 102 and stores the program. The CPU 104 implements functions related to the engagement estimation device 10 according to the program stored in the memory device 103. The interface device 105 is used as an interface for connection to a network. The display device 106 displays a GUI (Graphical User Interface) by the program or the like. The input device 107 is constituted by a keyboard, and a mouse, a button, or a touch panel, and is used to input various operation instructions.

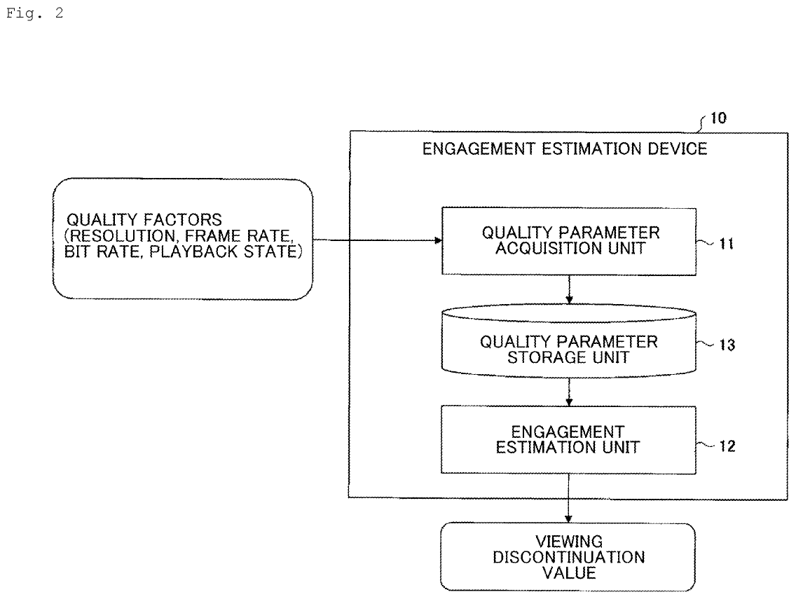

FIG. 2 is a view showing examples of functional elements of the engagement estimation device 10 in the embodiment of the present invention. In FIG. 2, the engagement estimation device 10 has a quality parameter acquisition unit 11 and an engagement estimation unit 12 in order to estimate engagement (viewing discontinuation) felt by a viewer at a certain elapsed time from a playback start for playback of a video in adaptive bit rate video streaming performed via a network. These individual units are implemented by processing which one or more programs installed in the engagement estimation device 10 cause the CPU 104 to execute. That is, these individual units are implemented by cooperation between hardware resources of the engagement estimation device 10 and the program (software) installed in the engagement estimation device 10. The engagement estimation device 10 also uses a quality parameter storage unit 13. The quality parameter storage unit 13 can be implemented by using, e.g., a storage device which can be connected to the auxiliary storage device 102 or the engagement estimation device 10 via a network.

For example, when an instruction to start viewing of a video by the adaptive bit rate video streaming (hereinafter referred to as “target video”) is issued, the quality parameter acquisition unit 11 acquires, for a preset measurement section (e.g., a unit such as one second, one minute, five minutes, or one hour, or each unit time of a chunk/segment unit used in video distribution (the unit time is assumed to be one second in the present embodiment)), parameters indicative of playback states such as a chunk start, a playback start waiting state, and a playback stop state in addition to parameters such as, e.g., a resolution, a frame rate, and a bit rate in the measurement section (or at the time of start or end of the measurement section) (hereinafter these parameters are collectively referred to as “quality parameters”) from, e.g., an application or the like which plays back the video, and the quality parameter acquisition unit 11 associates the acquired quality parameters with an elapsed time from a playback start, and stores the quality parameters in the quality parameter storage unit 13 in chronological order. Note that the application operates in a terminal for viewing. Accordingly, each quality parameter is data which can be observed in the terminal.

The engagement estimation unit 12 calculates an estimated value (hereinafter referred to as “viewing discontinuation value QR(t)”) of an index for assessing the engagement at a certain elapsed time t from the start of the playback of the target video (t=0 is satisfied when the playback is started) based on a history or the like of the quality parameters stored in the quality parameter storage unit 13. The value of t may be input by, e.g., a user, or may also be a cyclic value of each measurement section. In the present embodiment, the number of viewers who discontinue viewing (hereinafter referred to as “viewing-discontinuation viewer”) is used as the index. Specifically, a viewing discontinuation rate at the elapsed time t is described as an example of the viewing discontinuation value QR(t). Note that the viewing discontinuation rate at the elapsed time t denotes the rate of viewers who discontinue viewing cumulatively before the elapsed time t, and has a value between 0 and 1.

Note that the engagement estimation device 10 is, e.g., a computer which is used for the viewing of the adaptive bit rate video streaming (hereinafter referred to as “viewer terminal”). Specifically, a smartphone, a tablet terminal, or PC (Personal Computer) may be used as the engagement estimation device 10.

In the present embodiment, the engagement estimation unit 12 estimates the viewing discontinuation value by a method in the case where a playback stop is not present at the elapsed time t, and estimates the viewing discontinuation value by another method in the case where the playback stop is present at the elapsed time t. Note that the case where the playback stop is not present at the elapsed time t denotes a state in which the playback is not stopped at the elapsed time t, and the presence or absence of the occurrence of the playback stop at a point of time before the elapsed time t does not matter. Similarly, the case where the playback stop is present denotes a state in which the playback is stopped at the elapsed time t, and the presence or absence of the occurrence of the playback stop at a point of time before the elapsed time t does not matter.

First, a description will be given of a calculation method of the viewing discontinuation value QR(t) in the case where the playback stop is not present at the elapsed time t. In this case, an estimation formula of QR(t) (hereinafter referred to as “non-playback stop model”) is as follows.

$$\begin{matrix}QR ( t ) = QR ( {t}_{stalling \_ start} ) + \frac{t - {t}_{stalling \_ start}}{Δ {t}_{stalling}} \times U \\ U = {s}_{1} \times {t}_{{stalling}_{start}} + {s}_{2} \times Δ {t}_{stalling} + {s}_{3} + {MOS}_{video} \times {{Q}_{air}}^{{s}_{6}} \times ( {s}_{4} - {s}_{5} \times {t}_{{stalling}_{start}} ) + {s}_{7} \times {Q}_{air} \\ {Q}_{air} = QR ( max ( {t}_{ex \_ stalling \_ end} , {t}_{quality \_ change} ) )\end{matrix} \qquad [ Math . 1 ]$$

Herein, in the case where t=0 is satisfied, QR(t) is 0. In addition, t_{chunk_start} denotes an elapsed time at the time of start of playback of a video chunk (a start time of a video chunk, i.e., t_{chunk_start}<=t) which is played back at the elapsed time t (is being played back at the elapsed time t). MOS_{video} (x) denotes video quality at an elapsed time x. MOS_{audio} denotes audio quality at the elapsed time t. Note that each of the video quality and the audio quality is a value which is output with the bit rate, the resolution, the frame rate, a playback start waiting time, and a playback stop time used as inputs by a quality estimation technique such as ITU-T recommendation P. 1203.

t_{quality_change} denotes an elapsed time at a point of time when the video quality is changed latest before the elapsed time t (last before the elapsed time t). Note that, in the case where t_{quality_change} which meets the condition is not present (i.e., in the case where the video quality is not changed before the elapsed time t), t_{quality_change}=0 is satisfied and, there is no change of the video quality, and hence ΔMOS=0 is satisfied.

In addition, t_{ex_stalling_end} denotes an elapsed time at a point of time when the playback stop is ended latest before the elapsed time t (last before the elapsed time t). Note that, in the case where t_{ex_stalling_end} which meets the condition is not present (i.e., in the case where the playback stop is not ended before the elapsed time t), t_{ex_stalling_end}=0 is satisfied.

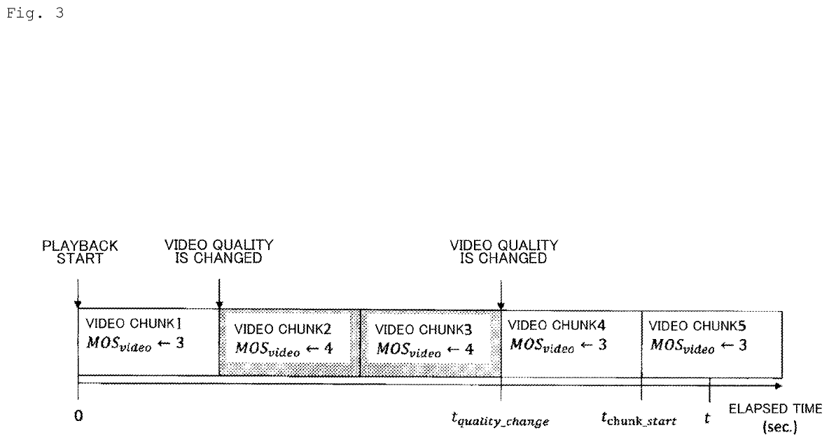

In addition, max(a, b) means one of values of a and b which is larger than the other. Further, c₁, c₂, c₃, c₄, c₅, and c₆ are coefficients. Note that λ is supposed to be a value of more than 0 and, in the case where λ is not more than 0, processing in the case where λ is not more than 0 such as replacing λ with a present minimum value or performing calculation with e\hat{ }(−(t−t_{chunk_start})/λ) of a calculation formula of QR(t) set to 0 is necessary. Note that FIG. 3 shows examples of t, t_{chunk_start}, t_{quality_change}, and t_{ex_stalling_end}.

A description will be given of characteristics of QR(t) in the case where the playback stop is not present at the elapsed time t. As basic characteristics, when the elapsed time t is increased, QR(t) is also increased. In addition, when MOS_{video}(t), MOS_{audio}, and Qₐₗᵣ have large values, the increase of QR(t) becomes gentle. In addition, in the case where ΔMOS<0 is satisfied, as its absolute value is increased, the increase of QR(t) is intensified. In the case where ΔMOS>0 is satisfied, as its absolute value is increased, the increase of QR(t) becomes gentle.

Next, a description will be given of a calculation method of the viewing discontinuation value QR(t) in the case where the playback stop is present at the elapsed time t. In this case, an estimation formula of QR(t) (hereinafter referred to as “playback stop model”) is as follows.

$$\begin{matrix}QR ( t ) = QR ( {t}_{stalling \_ start} ) + \frac{t - {t}_{stalling \_ start}}{Δ {t}_{stalling}} \times U \\ U = {s}_{1} \times {t}_{{stalling}_{start}} + {s}_{2} \times Δ {t}_{stalling} + {s}_{3} + {MOS}_{video} \times {{Q}_{air}}^{{s}_{6}} \times ( {s}_{4} - {s}_{5} \times {t}_{{stalling}_{start}} ) + {s}_{7} \times {Q}_{air} \\ {Q}_{air} = QR ( max ( {t}_{ex \_ stalling \_ end} , {t}_{quality \_ change} ) )\end{matrix} \qquad [ Math . 2 ]$$

Herein, t_{stalling_start} denotes an elapsed time at the time of start of the playback stop (a start time of the playback stop). Δt_{stalling} denotes a playback stop continuation time. MOS_{video} denotes the video quality at the elapsed time t. Note that the video quality is a value which is output with the bit rate, resolution, frame rate, playback start waiting time, and playback stop time used as inputs by the quality estimation technique such as ITU-T recommendation P. 1203. Note that, in the case where the playback stop is present, the influence of the audio quality on the viewing discontinuation value is small, and hence the audio quality is excluded from the estimation formula.

Further, t_{quality_change} denotes an elapsed time at a point of time when the video quality is changed latest before the elapsed time t (last before the elapsed time t). Note that, in the case where t_{quality_change} which meets the condition is not present (i.e., in the case where the video quality is not changed before the elapsed time t), t_{quality_change}=0 is satisfied, and QR(t_{quality_change})=QR(0)=0 is satisfied.

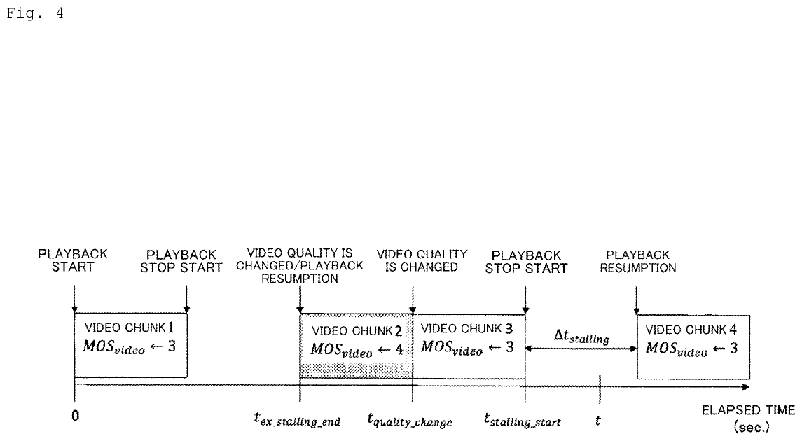

In addition, t_{ex_stalling_end} denotes an elapsed time at a point of time when the playback stop is ended latest before the elapsed time t (last before the elapsed time t). Note that, in the case where t_{ex_stalling_end} which meets the condition is not present (i.e., in the case where the playback stop is not ended before the elapsed time t), t_{ex_stalling_end}=0 is satisfied. Further, s₁, s₂, s₃, s₄, s₅, s₆, and s₇ are coefficients. Note that FIG. 4 shows examples of t, t_{ex_stalling_start}, Δt_{stalling}, and t_{quality_change}.

A description will be given of characteristics of QR(t) in the case where the playback stop is present at the elapsed time t. When Δt_{stalling} is increased, QR(t) is also increased. In addition, when the MOS_{video} is increased, QR(t) is reduced in a relationship between MOS_{video} and QR(t).

Thus, in each of the non-playback stop model and the playback stop model, the viewing discontinuation value Q(t) at a point of time (measurement section) previous to the elapsed time t is cumulatively (or recursively) calculated, and the viewing discontinuation value Q(t) at the elapsed time t is calculated. In addition, as is clear from the above description, the viewing discontinuation value Q(t) is calculated such that the stop of the playback influences the viewing discontinuation value Q(t) more significantly in the playback stop model than in the non-playback stop model.

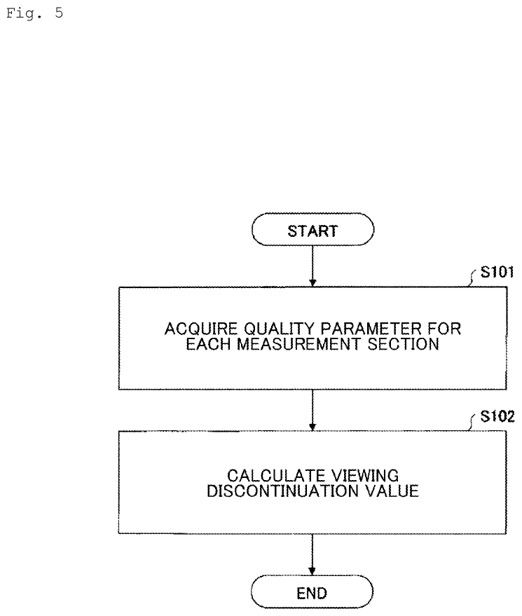

Hereinbelow, a description will be given of a processing procedure executed by the engagement estimation device 10. FIG. 5 is a flowchart for explaining an example of the processing procedure executed by the engagement estimation device 10.

In Step S101, the quality parameter acquisition unit 11 acquires the quality parameters in each measurement section from the start of the playback of an assessment-target video (target video) to the end of the playback, and stores the acquired quality parameters in the quality parameter storage unit 13.

Thereafter, at any timing (e.g., timing when the estimation of the viewing discontinuation value QR(t) is requested by a user), the engagement estimation unit 12 calculates the viewing discontinuation value QR(t) related to the target video at the elapsed time t based on the history or the like of the quality parameters stored in the quality parameter storage unit 13 (S102). The elapsed time t may be set at the end of each measurement section from the start of the playback of the target video to the end of the playback, or may also be any one value. In the case of the former, the viewing discontinuation value QR(t) is obtained for each measurement section (every second). In the case of the latter, the viewing discontinuation value QR(t) of any one elapsed time t is obtained.

Note that S101 and S102 may also be performed in synchronization with each other for each measurement section. In this case, the viewing discontinuation value QR(t) is obtained for each measurement section.

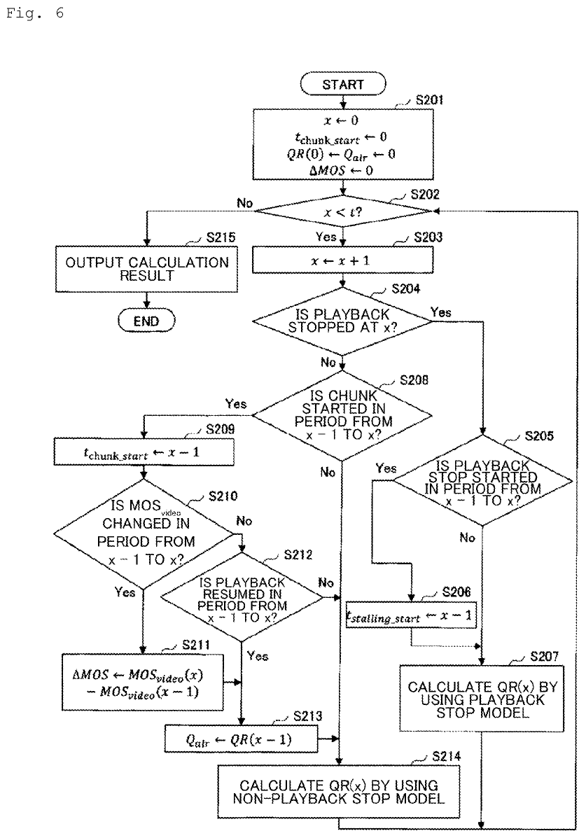

Then, a description will be given of the detail of Step S102. FIG. 6 is a flowchart for explaining an example of a processing procedure of calculation processing of the viewing discontinuation value.

In Step S201, the engagement estimation unit 12 initializes various variables used in the processing procedure in FIG. 6. Specifically, a variable x for storing a previous elapsed time before t is initialized to 0. In addition, t_{chunk_start}, QR(0), Qₐₗₜ, and ΔMOS are initialized to 0.

Then, the engagement estimation unit 12 compares values of t and x (S202). t is a numerical value indicative of the elapsed time of a calculation target of the viewing discontinuation value QR(t). In the present embodiment, the unit of the measurement section is one second, and hence the unit of each of t and x is a second. In the case where x is less than t (Yes in S202), the engagement estimation unit 12 adds 1 to x (S203). Then, the engagement estimation unit 12 determines whether or not the playback of the target video is stopped at an elapsed time x by referring to the quality parameter storage unit 13 (S204).

In the case where the playback of the target video is stopped at the elapsed time x (Yes in S204), the engagement estimation unit 12 determines whether or not the playback stop is started in a period from x−1 to x by referring to the quality parameter storage unit 13 (S205). Herein, the period from x−1 to x denotes a period before x (including x) after x−1, and the same applies to the following description. In the case where the playback stop is started in the period from x−1 to x (Yes in S205), the engagement estimation unit 12 assigns x−1 to t_{stalling_start} (S206).

In the case of No in Step S205, or subsequently to S206, the engagement estimation unit 12 calculates a viewing discontinuation value QR(x) at the elapsed time x by using the playback stop model (S207), and returns to Step S202.

On the other hand, in the case where the playback of the target video is not stopped at the elapsed time x (i.e., in the case where the target video is being played back) (No in S204), the engagement estimation unit 12 determines whether or not a start time point (start time) of any chunk of the target video is included in the period from x−1 to x by referring to the quality parameter storage unit 13 (S208). In the case where the start time point of any chunk is included in the period from x−1 to x (Yes in S208), the engagement estimation unit 12 assigns x−1 to t_{chunk_start} (S209). Then, the engagement estimation unit 12 determines whether or not MOS_{video} is changed in the period from x−1 to x (whether or not MOS_{video} (x−1) is different from MOS_{video}(x)) by referring to the quality parameter storage unit 13 (S210). Note that MOS_{video} at x−1 can be calculated based on the quality parameter related to x−1 stored in the quality parameter storage unit 13. Similarly, MOS_{video} at x can be calculated based on the quality parameter related to x stored in the quality parameter storage unit 13.

In the case where MOS_{video} is changed in the period from x−1 to x (Yes in S210), the engagement estimation unit 12 assigns a value obtained by subtracting MOS_{video}(x−1) from MOS_{video}(x) to ΔMOS (S211). On the other hand, in the case where MOS_{video} is not changed in the period from x−1 to x (No in S210), the engagement estimation unit 12 determines whether or not the playback is resumed (has recovered from the playback stop) in the period from x−1 to x by referring to the quality parameter storage unit 13 (S212).

In the case where the playback is resumed in the period from x−1 to x (Yes in S212), or subsequently to Step S211, the engagement estimation unit 12 assigns QR(x−1) to Qₐₗₜ (S213).

Subsequently to Step S213 or the case of No in Step S208, the engagement estimation unit 12 calculates the viewing discontinuation value QR(x) at the elapsed time x by using the non-playback stop model (S214), and returns to Step S202.

When the above processing procedure is repeated and the value of the variable x reaches t (No in S202), the engagement estimation unit 12 outputs the calculation result in Step S207 or S214 which is executed last as the viewing discontinuation value QR(t) (S215).

Thus, the viewing discontinuation value QR(t) is calculated cumulatively by using the previous viewing discontinuation value QR.

As described above, according to the present embodiment, it is possible to allow the estimation of the engagement from the parameters which can be observed in the terminal.

Consequently, according to the present embodiment, by monitoring the engagement value of the communication service which is actually viewed by the viewer, it is possible to easily determine whether or not the service which is being provided maintains engagement of a certain level or higher for the viewer, and it becomes possible to understand and manage the actual state of the engagement of the service which is being provided in real time.

In addition, the engagement is influenced not only by the real-time quality parameter (the playback stop or the like) but also by the previous quality parameter and, in the present embodiment, it is possible to estimate the engagement in consideration of the previous quality parameter.

While the embodiment of the present invention has been described in detail thus far, the present invention is not limited to the specific embodiment, and various modifications and changes can be made within the scope of the gist of the present invention described in the scope of claims.

### REFERENCE SIGNS LIST

10 Engagement estimation device
11 Quality parameter acquisition unit
12 Engagement estimation unit
13 Quality parameter storage unit
100 Drive device
101 Recording medium
102 Auxiliary storage device
103 Memory device
104 CPU
105 Interface device
106 Display device
107 Input device
B Bus

1. An engagement estimation device comprising:
an engagement estimation unit, including one or more processors, configured to calculate an estimated value of an index for assessing engagement of a viewer of a video at a certain elapsed time from a start of playback of the video distributed via a network, wherein the engagement estimation unit is configured to calculate the estimated value such that, in a case where the playback of the video is stopped at the certain elapsed time, the stop of the playback influences the estimated value more significantly than in a case where the playback of the video is not stopped at the certain elapsed time.

2. The engagement estimation device according to claim 1, wherein, in the case where the playback of the video is stopped at the certain elapsed time, the engagement estimation unit is configured to calculate the estimated value at a start time of the stop, and calculate the estimated value at the certain elapsed time based on the estimated value at the start time.

3. The engagement estimation device according to claim 1, wherein, in the case where the playback of the video is not stopped at the certain elapsed time, the engagement estimation unit is configured to calculate the estimated value at a start time of a chunk which is being played back, and calculates the estimated value at the certain elapsed time based on the estimated value at the start time.

4. An engagement estimation method comprising:
causing a computer to execute an engagement estimation procedure which calculates an estimated value of an index for assessing engagement of a viewer of a video at a certain elapsed time from a start of playback of the video distributed via a network, wherein the engagement estimation procedure calculates the estimated value such that, in a case where the playback of the video is stopped at the certain elapsed time, the stop of the playback influences the estimated value more significantly than in a case where the playback of the video is not stopped at the certain elapsed time.

5. The engagement estimation method according to claim 4, wherein, in the case where the playback of the video is stopped at the certain elapsed time, the engagement estimation procedure calculates the estimated value at a start time of the stop, and calculates the estimated value at the certain elapsed time based on the estimated value at the start time.

6. The engagement estimation method according to claim 4, wherein, in the case where the playback of the video is not stopped at the certain elapsed time, the engagement estimation procedure calculates the estimated value at a start time of a chunk which is being played back, and calculates the estimated value at the certain elapsed time based on the estimated value at the start time.

7. A non-transitory computer readable medium storing a program for causing a computer to function as an engagement estimation device to:
calculate an estimated value of an index for assessing engagement of a viewer of a video at a certain elapsed time from a start of playback of the video distributed via a network,
wherein the engagement estimation device is configured to calculate the estimated value such that, in a case where the playback of the video is stopped at the certain elapsed time, the stop of the playback influences the estimated value more significantly than in a case where the playback of the video is not stopped at the certain elapsed time.

8. The non-transitory computer readable medium according to claim 7, wherein, in the case where the playback of the video is stopped at the certain elapsed time, the engagement estimation device is configured to calculate the estimated value at a start time of the stop, and calculates the estimated value at the certain elapsed time based on the estimated value at the start time.

9. The non-transitory computer readable medium according to claim 7, wherein, in the case where the playback of the video is not stopped at the certain elapsed time, the engagement estimation device is configured to calculate the estimated value at a start time of a chunk which is being played back, and calculates the estimated value at the certain elapsed time based on the estimated value at the start time.
